(19) United States
(12) Patent Application Publication
(10) Pub. No.: US 2010/0293965 A1
(43) Pub. Date: Nov. 25, 2010

(54) METHOD AND SYSTEM FOR REDUCED ENERGY IN A BEVERAGE MACHINE

(75) Inventors: Jimmy I. FRANK, Houston, TX (US); Craig CLOUD, New Braunfels, TX (US)

Correspondence Address: LOCKE LORD BISSELL & LIDDELL LLP, 600 TRAVIS SUITE 2800, HOUSTON, TX, 77002-3095, US

(73) Assignee: FBD PARTNERSHIP, LP, San Antonio, TX (US)

(21) Appl. No.: 12/782,021

(22) Filed: May 18, 2010

Related U.S. Application Data
(60) Provisional application No. 61/179,809, filed on May 20, 2009.

(51) Int. Cl. A23L 3/36

(52) U.S. Cl. 62/1

(57) ABSTRACT

The disclosure provides an improved method and system for reducing energy in a beverage machine. The disclosure provides for a reduced operation of a mixer motor in the beverage machine that still allows for testing product conditions and ensuring product quality unique to the needs of beverage dispensing. The product remains cooled or frozen longer, thus reducing compressor operation in a refrigeration system and heat input into the surrounding environment, such as a store, that further reduces the cooling needs of the environment for an overall reduced energy consumption with the beverage machine. The invention departs from the standard of continuous mixing to ensure product quality and reduces the energy input into the mixer motor and energy input into the product chamber, thus reducing the compressor reactivation frequency for significant energy savings.

### CROSS REFERENCE TO RELATED APPLICATIONS

This application claims the benefit of U.S. Provisional Application No. 61/179,809, filed May 20, 2009, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

This disclosure relates to a method and system of reduced energy consumption related to the operation of food machines. More specifically, the disclosure relates to a method and system of reduced energy consumption related to the operation of beverage machines, such as frozen beverage machines.

2. Description of the Related Art

Energy conservation in beverage equipment has largely been ignored in the past. Energy conversation has been largely ignored especially in frozen beverage machines that include mixing devices and other components that heretofore have used substantially continuous mixing. In frozen beverage machines, product quality overrides energy conservation concerns. For frozen beverage machines that dispense a semi-frozen or slushy beverage product (herein “frozen beverage product”), the beverage product is continuously mixed and monitored for viscosity and related conditions, such as temperature, taste, gas content, and other conditions that affect the product quality. The paramount goal is to have consistent and high quality frozen beverage products for immediate delivery to a customer upon demand. Because the beverage product quality is paramount, a mixer motor with a mixer disposed in the beverage product is operated continuously and continuously monitored for power usage to determine viscosity of a frozen product in a frozen beverage machine. The power input to the mixer motor varies with the product viscosity, as a condition of the frozen product, which in turn indicates the temperature, and other conditions. Thus, energy conservation historically has been subservient to the particular requirements of beverage product quality in the beverage machines.

In addition to the mixer operation described above, a typical beverage machine that offers frozen beverages uses a refrigeration system. For a frozen beverage machine, the refrigeration system is used to freeze ingredients of a frozen beverage to a semi-frozen state or slush state (herein “frozen”). When the product reaches the desired condition, such as temperature or frozen state, the compressor turns off and stays off until the product has thawed to a point that is approaching an unacceptable texture or other condition for a frozen beverage.

There are several sources of heat in beverage machines which cause the product to warm and/or thaw, and thus requires energy input to reestablish desired conditions. The commonly recognized sources of heat are: a beverage is dispensed and warm product and/or ingredients enter the product chamber to replenish; and a heat loss from the product chamber. The first source is unavoidable, but can be minimized by pre-chilling the product ingredients entering the product chamber. However, pre-chilling also requires some form of refrigeration, so there is actually no total energy savings. The second source of heat is actually a heat loss from the product chamber to the environment and can be reduced by increasing insulation around the product chamber, if the existing insulation is not already sufficiently thick to effectively reduce heat transfer between the frozen product and the environment. A large zone of heat loss is at a faceplate of the product chamber and is typically accommodated by using a thicker material or a material with better insulative properties.

Therefore, there remains a need for further reducing energy in beverage machines while still maintaining the required high quality products unique to the beverage industry, particularly for frozen beverage products.

### SUMMARY OF THE INVENTION

The disclosure provides an improved method and system for reducing energy in a beverage machine. The disclosure provides for a reduced operation of a mixer motor in the beverage machine that still allows for testing product conditions and ensuring product quality unique to the needs of beverage dispensing. The product remains frozen longer, thus reducing compressor operation in a refrigeration system and heat input into the surrounding environment, such as a store, that further reduces the cooling needs of the environment for an overall reduced energy consumption with the beverage machine. The invention departs from the standard of continuous mixing to ensure product quality and reduces the energy input into the mixer motor and energy input into the product chamber, thus reducing the compressor reactivation frequency for significant energy savings.

The disclosure provides a method of operating a beverage machine having a product chamber for containing a product, a compressor motor with a compressor for cooling the product, and a mixer motor with a mixer for mixing the product in the product chamber, comprising: activating the compressor motor to cool the product so that the product reaches a predefined first product condition; activating the mixer motor with the mixer to mix the product in the product chamber; deactivating the compressor motor; deactivating the mixer motor to stop the mixer from mixing based on an occurrence of a predefined first condition while the product is in the chamber and the compressor motor is deactivated; reactivating the mixer motor based on an occurrence of a predefined second condition different from the first condition while the product is in the chamber and the compressor motor is deactivated; and reactivating the compressor motor when the product reaches a predefined second product condition.

The disclosure also provides a system for reducing energy input into a beverage machine, comprising: at least one product chamber adapted to contain a product; a compressor motor with a compressor adapted to cool the product; a mixer motor with a mixer adapted to mix the product in the product chamber; a controller coupled to the compressor motor and mixer motor and adapted to: activate the compressor motor to cool the product so that the product reaches a predefined first product condition; activate the mixer motor with the mixer to mix the product in the product chamber; deactivate the compressor motor; deactivate the mixer motor to stop the mixer from mixing based on an occurrence of a predefined first condition while the product is in the chamber and the compressor motor is deactivated; reactivate the mixer motor to mix the product in the product chamber based on an occurrence of a predefined second condition different from the first condition while the product is in the chamber and the compressor motor is deactivated; and reactivate the compressor motor when the product reaches a predefined second product condition.

### BRIEF DESCRIPTION OF THE SEVERAL VIEWS OF THE DRAWINGS

FIG. 1 is a schematic diagram of an exemplary beverage machine.

FIG. 2 is a perspective schematic diagram of an exemplary mixer in a product chamber.

FIG. 3 is a chart of exemplary test data for a beverage machine illustrating different viscosity change rates of a frozen beverage for different activation/deactivation periods as a function of time.

FIG. 4 is a chart of exemplary energy savings based on reduced power input to the beverage machine from test data described in FIG. 3.

FIG. 5 is a table of activation percentages of the mixer motor and the resulting energy savings with the beverage machine.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. Where appropriate, elements have been labeled with an “a” or “b” to designate one side of the system or another. When referring generally to such elements, the number without the letter is used. Further, such designations do not limit the number of elements that can be used for that function.

In general, the disclosure provides an improved method and system for reducing energy in a beverage machine. The disclosure provides for a reduced operation of a mixer motor in the beverage machine that still allows for testing product conditions and ensuring product quality unique to the needs of beverage dispensing. The product remains frozen longer, thus reducing compressor operation in a refrigeration system and heat input into the surrounding environment, such as a store, that further reduces the cooling needs of the environment for an overall reduced energy consumption with the beverage machine. The invention departs from the standard of continuous mixing to ensure product quality and reduces the energy input into the mixer motor and energy input into the product chamber, thus reducing the compressor reactivation frequency for significant energy savings.

The inventors realized that there was a third source of heat that was input into beverage machines that was overlooked by their peers and in other systems. The inventors realized that this third source of heat had the greatest potential for improvement for most frozen beverage equipment and is the subject of patent, generally by allowing the compressor to cycle less when less heat is input into the system through non-continuous mixing. While in hindsight the improvement can seem incremental, the result can be significant and has escaped the notice of others with ordinary skill in the art.

As described above, to maintain an optimal frozen texture or beverage temperature, the mixer motor and mixer operates at substantially all times in each beverage machine's product chamber. This constant use provides constant mixing and a continuous measure of the product condition in order to determine when the refrigeration cycle must start to refreeze the product to an optimum texture or cool the beverage to an optimum temperature. However, the continuous mixing adds heat energy to the product and thaws or warms the product. If the mixer is turned off, less heat energy is added to the product. Less energy slows down the warming or thawing process.

This revelation of the inventors has at least three categories of energy reduction. First, as mentioned above, the energy input into the product itself is reduced. The product does not thaw as quickly or warm as quickly. Thus, the cooling cycle from a refrigeration system is not as frequent and the compressor motor does not cycle as often. Second, the actual reduced operational time of the mixer motor directly reduces the energy input into the beverage machine. Third, the energy input into a surrounding enclosed space, such as a store or room, is reduced because the compressor motor, the mixer motor, or both have a reduced energy input and reduced heat output. The enclosed space has a lower heat load and a lower cooling requirement.

The energy reduction can be significant. Calculations based on current electrical rates are estimated at several millions of dollars per year for some companies in the frozen beverage business.

Having explained various aspects of the disclosure, attention is turned to one or more nonlimiting and exemplary embodiments.

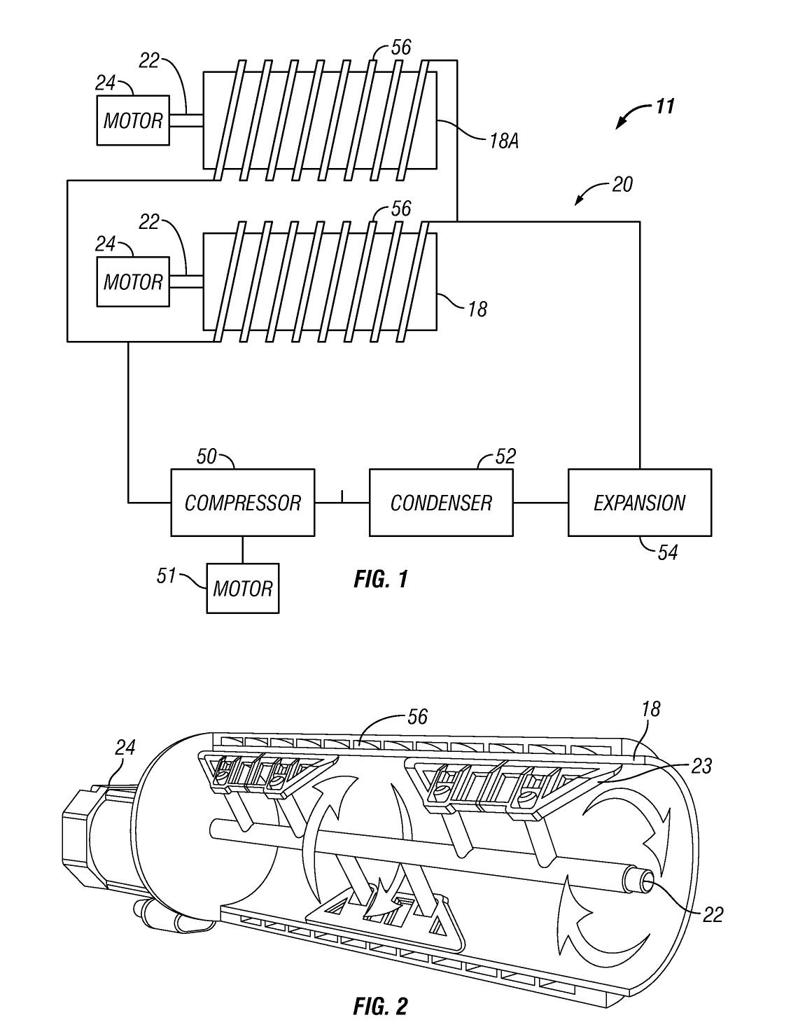

FIG. 1 is a block diagram schematically illustrating portions of a beverage machine 11. FIG. 2 is a perspective schematic diagram of an exemplary mixer in a product chamber. The figures will be described in conjunction with each other. The beverage machine 11 includes a product chamber 18, and a rotating shaft 22 coupled to a mixer 23 having a plurality of outwardly projecting blades disposed inside the chamber 18. The shaft 22 is driven by a mixer motor 24, such that the blades mix the ingredients and scrape the frozen mixture off the inside wall of the product chamber 18 for a frozen beverage machine. Some beverage machines have multiple product chambers 18A with their own mixer motor 24, shaft 22, and mixer 23.

For a frozen beverage machine, the refrigeration system 20 includes a compressor 50, a condenser 52, an expansion valve 54, and an evaporator coil 56 surrounding the product chamber 18. The compressor 50 with a compressor motor 51 provides the motive force for the particular refrigerant contained within the refrigeration system 20. The compressor 50 forces the refrigerant through the condenser 52, where the refrigerant vapor liquefies. The liquid refrigerant passes through the expansion valve 54, expanding the high-pressure liquid refrigerant to a low-pressure vapor. The low-pressure, low-temperature refrigerant discharged from the thermostatic expansion valve 54 is then directed through the evaporator coil 56 for absorbing heat and thus refrigerating the product chamber 18 surrounded by the evaporator coil 56.

In some embodiments, such as frozen beverage machines, the compressor motor 51 with the compressor 50 can be activated and deactivated based on the viscosity of the frozen beverage. At startup, the compressor motor can be activated so that the beverage product reaches a desired first viscosity for a predetermined first product condition, and then deactivated. The compressor motor can be reactivated (that is, turned back on) when a second viscosity (generally a lower viscosity) as a predetermined second product condition occurs to restore the product to the first product condition.

In further embodiments, other product conditions can be monitored to determine the state of the beverage mixture, and the compressor motor operated in response to the measured variable(s). For example, the temperature of the product may be monitored using any appropriate means, such as a thermometer. The compressor motor 51 could then be activated in response to the product temperature reaching a predetermined thaw or warm temperature and deactivated upon the product reaching a desired frozen or cooled temperature.

The torque of the mixer motor 24 can be monitored to determine the condition of the beverage product within the product chamber 18 for a frozen beverage machine. When the mixture is in a relatively thawed, liquid state, the torque required to turn the shaft 22 is relatively low. As the mixture becomes more frozen, more torque is required to turn the shaft 22. Thus, in such an embodiment, the beverage product viscosity represents a monitored product condition between a desired and predetermined first product condition and a predetermined second product condition indicated by the amount of motor torque required to turn the shaft 22. The motor torque can be directly monitored by the power input required for the mixer motor 24 to turn the shaft 22 coupled to the mixer 23.

In some embodiments, the operation of the mixer motor 24 can be timed, such as in a stepped fashion, so that the motor operates for a set time and stops for a set time. The timing can be based on the product conditions of temperature, viscosity, and/or other conditions, and can occur during the compressor being activated to periodically test the product condition and mix the product. The timing can be determined through experimental uses of particular configurations and set accordingly.

Further, the normal operation of the mixer motor 24 can be overridden to start at other events that may affect one or more product conditions. For example, if an amount of beverage is withdrawn from the product chamber 11, the beverage machine may activate a filling operation to refill the product chamber. In such case, the added ingredients will likely need cooling or freezing. A sampling test can be made to determine the product condition(s) in question, such as viscosity, temperature, or other product conditions. If the compressor motor 51 and compressor 50, and the mixer motor 24 and mixer 23 are in a standby state of deactivation, the mixer motor 24 can be activated to mix and test the viscosity through the motor torque described above or other recognized procedures. If the viscosity is low, the system can activate the compressor and freeze the product. If the viscosity is in a normal range, then the compressor can remain deactivated. The mixer motor 24 can become deactivated after testing the product.

As another example of events overriding a normal operation, the compressor can be allowed to cool another product chamber in the beverage machine out of sequence while it is cooling a first product chamber that is in sequence. The efficiency gained by cooling multiple chambers from a compressor at the same time is considered greater than cooling each chamber (albeit with a smaller load) at different times. The first product chamber may indicate a product condition that needs the compressor to be activated, directly or through timed events that empirically indicate a product condition such as thawing. If the beverage machine includes more than one product chamber such as two, three, four, or more chambers, then the beverage machine can sample other product chambers or use empirical values, such as time, to determine the product condition in one or more of the other product chambers. If one or more of the other product chambers indicates a product condition that is nearing a need for a cooling cycle, then the compressor can temporarily change the cooling cycle of at least a second chamber to coincide with a cooling cycle of the first chamber to allow the compressor to cool the chambers concurrently, even though at least a second chamber is out of cycle. One exemplary metric to determine whether to cool another chamber out of cycle is whether a product condition (such as timing, temperature, viscosity, and so forth) of that chamber is above or below a midpoint value of a product condition range to indicate a need for a cooling cycle, so that the chamber would be cooled if the condition was above the midpoint value.

### Experiment 1

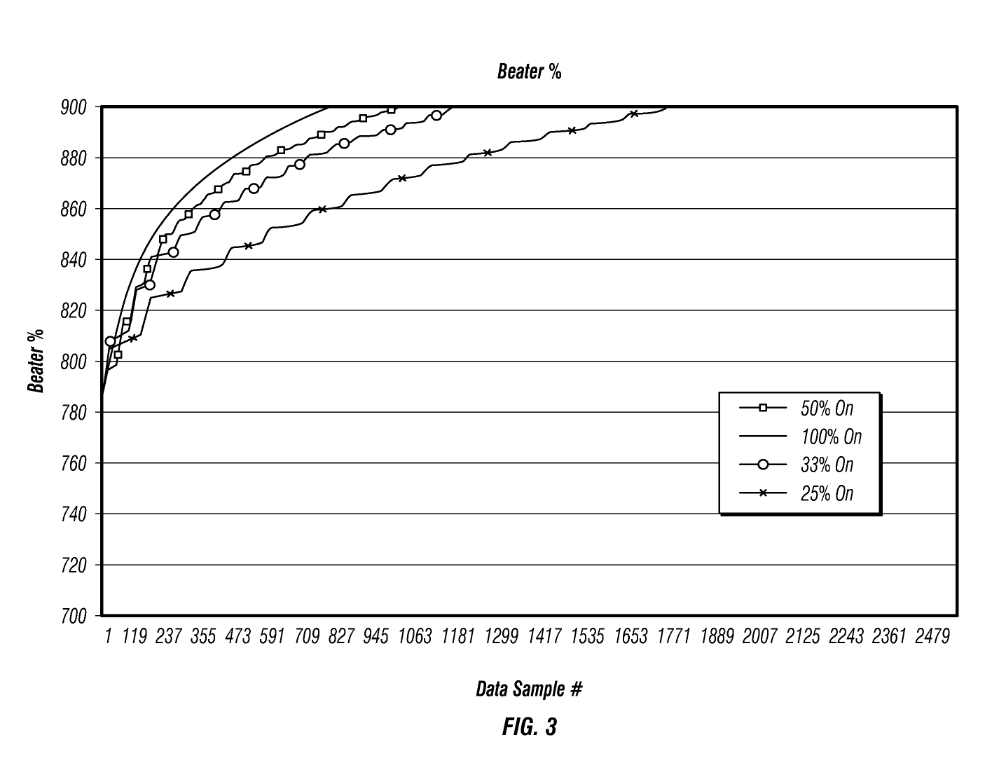

FIG. 3 is a chart of exemplary test data for a beverage machine illustrating different viscosity change rates of a frozen beverage for different activation/deactivation periods as a function of time. As a non-limiting example of test data that can be developed according to the teachings of this disclosure, FIG. 3 illustrates the viscosity of a beverage viscosity changing with temperature, such as a frozen beverage, over time and the effect that different activation/deactivation times can have on the viscosity changes and other product conditions. While the viscosity can be measured or determined in a number of ways, one exemplary method is to measure power input to the mixer motor, as described above. Power input in watts can be measured over time as one or more product conditions change. In other embodiments, temperature can be measured directly. Other conditions suitable to the type of beverage can also be measured in addition to or in lieu of viscosity.

The units in the charts are expressed as “Beater %” for the X-Axis and “Data Sample #” on the Y-Axis. Beater percentage is a selected unit-less term used for normalized comparisons between different machines of different capacities and refers to the operation of the mixer in the product chamber through the power input to the mixer motor. The beater % is a relative value to be compared against a liquid state viscosity, wherein a beater % value of 1000 indicates the product chamber is completely liquid with a corresponding low viscosity, and a beater % value of 0 indicates the mixer motor does not turn, either from being deactivated or unable to turn if the viscosity is too high. As the product starts to freeze down, the beater percentage drops.

The compressor activation/deactivation (i.e., on/off) limits in this example are 900% and 800%, respectively. The data shown in the chart was collected beginning when the compressor shut off at a beater percentage of 800. There is a slight overshoot of data at the beginning of the X-Axis due to electronic filtering and other system particularities. The data was collected until the beater percentage reached 900%. At least four (4) different activation/deactivation times for the mixer motor were used, expressed as a percentage of activation time divided by the sum of the activation time plus deactivation time as follows: 15 seconds (sec.) activated time divided by the sum 15 sec. activated time plus 1 sec. deactivated) time equals 94% activated time or approximately 100% for purposes herein. Other values were 15 sec. activated and 15 sec. deactivated (15/(15+15)=50% activated), 15 sec. activated and 30 sec. deactivated (15/(15+30)=33% activated), and 20 sec. activated and 60 sec. deactivated (20/(20+60)=25% activated). The time that the product remained between 800 and 900 beater percentage (i.e., remained frozen in an acceptable viscosity) increased considerably when the mixer motor was not activated as much as in prior efforts of those in the art. For example, from a beater % of 800% to 900%, the time at 100% mixer motor activation was about 760 data samples; the time at 50% mixer motor activation was about 990 data samples; the time at 33% mixer motor activation was about 1150 data samples; and the time at 25% mixer motor activation was about 1740 data samples. The increase in time that the beverage remained between the selected beater % limits of 800% and 900% was for 50% activation an increased percentage of 30% ((990−760)/760), for 33% activation was an increased percentage of 50% (1150−760)/760) and for 25% activation was an increased percentage of 130% (1740−760)/760).

It was noticed in the experiment that the product consistency and quality deteriorated at about 25% activation for the particular activation/deactivation times used above. Thus, an activation percentage of between about 50% and 33% (in any increment) can have valuable energy savings and still provide quality product. In some experiments, the quality appears to have improved with non-continuous mixing, which herefore has been considered desirable for high quality frozen beverage products. Various and/or other percentages (and any integers or fractions therebetween) can be used, and different activation/deactivation times even for a given percentage can be used and optimized for a given machine, product, or a combination thereof. For example, an activation percentage between 10% and 90% could have effects on energy savings, an activation percentage between 25% and 75% could be advantageous, and an activation percentage between 33% and 50% could be particularly advantageous, where the ranges stated are inclusive and can be any percentage therebetween, including any fractional percentages. Thus, the above percentages and activation/deactivation times are merely exemplary and are not limiting, and are offered to provide support in keeping with the requirements of disclosure under applicable patent statutes.

The longer the beverage can stay within the selected range, the more time between compressor activations to cool or refreeze the product, as in this example. The less the compressor has to operate, the less energy is input to the beverage machine. Further, the less time the mixer has to operate, the less further energy is input to the beverage machine. When less energy is input to the beverage machine, then less energy is output to the surrounding area, such as a store or room in which the beverage machine is installed. Less energy output from the beverage machine into the surrounding area means the cooling system for the surrounding area has to operate less and thus additional energy is saved.

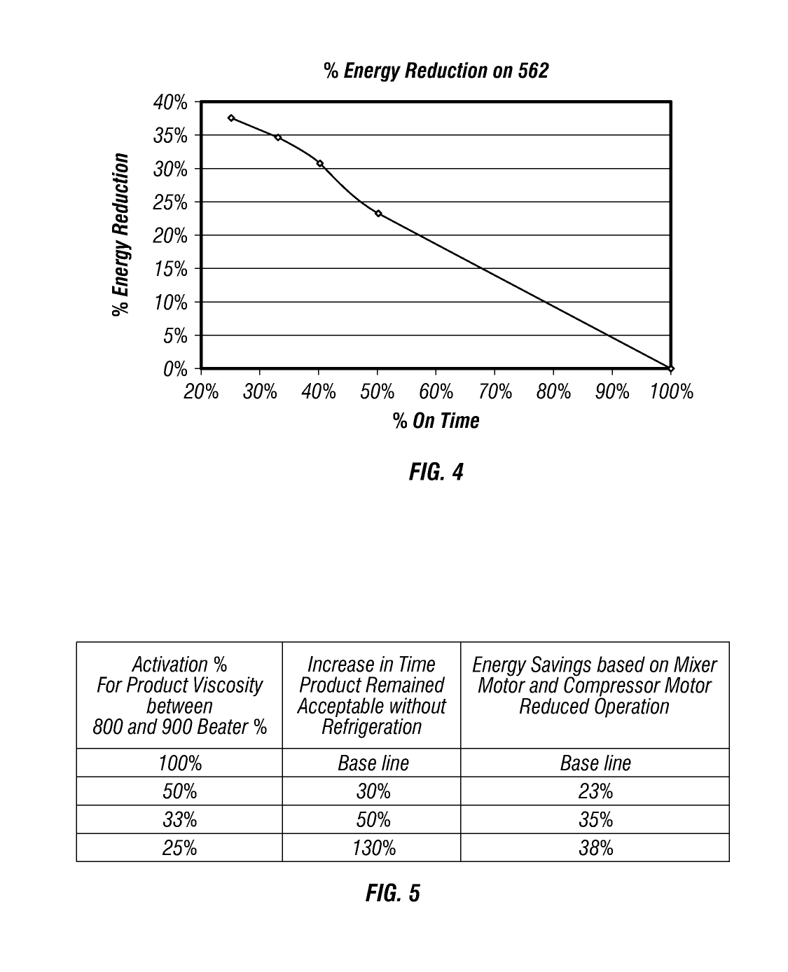

FIG. 4 is a chart of exemplary energy savings based on reduced power input to the beverage machine from test data described in FIG. 3. During the Experiment 1 for the different activation percentages, the power input in watts was measured to the beverage machine 11, shown in FIGS. 1 and 2. The chart in FIG. 4 shows the results of the power input to the beverage machine at different percentages of mixer motor activation related to the beater percentage described above. For an activation of 100%, the energy savings was zeroed as a base line value to compare the other percentages. At 50% activation, the energy savings was about 23% for the beverage machine operation. At 33% activation, the energy savings was about 35% for the beverage machine operation. At 25% activation, the energy savings was about 38% for the beverage machine operation. Although not included in the chart of FIG. 3, an additional data point for the energy savings is shown in FIG. 4, namely, at 40% activation, the energy savings was about 31%. Importantly, other energy savings are presumed to occur, because the compressor is needed less often when the product remains between the acceptable quality limits longer in addition to the mixer motor operating less frequently, and the less heat output to the surrounding area causes its own cooling system to operate less often.

FIG. 5 is a table of activation percentages of the mixer motor and the resulting energy savings with the beverage machine. The table summarizes the exemplary activation times and energy savings described in Experiment 1 and regarding FIGS. 3 and 4. Even for the range of between 33% and 50% for activation percentages, the energy savings can be 35% to 23% respectively. Further, the energy savings for the power input to the beverage machine shown in FIG. 5 excludes other savings to the surrounding area from the reduced heat load. Still further, it can be possible that the number of defrost cycles is reduced due to less compressor cycling for additional energy savings. Thus, the energy savings can be significant.

Other and further embodiments utilizing one or more aspects of the inventions described above can be devised without departing from the spirit of the invention. For example, the principles above can be applied by one with ordinary skill in the art to a fountain beverage machine or other beverage machines to reduce the energy input into such machines. For fountain beverage machines, a cooling medium is continuously circulated over a cooling source, such as an ice block that is created by a compressor refrigeration system, and the beverage product is cooled as it is circulated though the cooling medium in coils as the beverage product is dispensed. In a typical fountain beverage machine, a mixer motor on a fountain beverage machine can be operated continuously and the thickness of an ice block is be monitored and regenerated as necessary by periodically activating the compressor. Because the fluid in the chamber that is frozen is not the beverage consumed by the consumer, but merely the cooling medium for the beverage, then the term “product” herein may be viewed broadly. Thus, for purposes herein, the term “product” can include a beverage product (such as can be directly cooled in a beverage product chamber in a frozen beverage machine), a cooling medium for cooling the beverage product (such as the cooling medium held in a product chamber of a fountain beverage machine that in turn cools the beverage product circulating through coils in the product chamber), or a combination thereof.

Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of operating a beverage machine having a product chamber for containing a product, a compressor motor with a compressor for cooling the product, and a mixer motor with a mixer for mixing the product in the product chamber, comprising:
activating the compressor motor to cool the product so that the product reaches a predefined first product condition;
activating the mixer motor with the mixer to mix the product in the product chamber;
deactivating the compressor motor;
deactivating the mixer motor to stop the mixer from mixing based on an occurrence of a predefined first condition while the product is in the chamber and the compressor motor is deactivated;
reactivating the mixer motor based on an occurrence of a predefined second condition different from the first condition while the product is in the chamber and the compressor motor is deactivated; and
reactivating the compressor motor when the product reaches a predefined second product condition.

2. The method of claim 1, wherein reactivating the compressor motor occurs with less frequency due to the step of deactivating the mixer motor based on the occurrence of the predefined first condition compared to reactivating the compressor motor without the step of deactivating the mixer motor based on the occurrence of the predefined first condition.

3. The method of claim 1, wherein an activation time for the mixer motor compared to a sum of the activation time and a deactivation time for the mixer motor while the compressor motor is deactivated is expressed as an mixer activation percentage, and the activation percentage is 10% to 90%.

4. The method of claim 3, wherein the activation percentage is 25% to 75%.

5. The method of claim 3, wherein the activation percentage is 33% to 50%.

6. The method of claim 1, wherein the predefined first condition comprises a first time.

7. The method of claim 6, wherein the predefined second condition comprises a second time.

8. The method of claim 1, wherein the predefined first product condition comprises a first product temperature of the product.

9. The method of claim 8, wherein the predetermined second product condition comprises a second product temperature of the product different from the first product temperature.

10. The method of claim 1, wherein the predefined first product condition comprises a first viscosity of the product in the chamber.

11. The method of claim 10, wherein the predefined second product condition comprises a second viscosity of the product in the chamber different from the first viscosity.

12. The method of claim 11, wherein a difference between the first viscosity and the second viscosity is based on a difference in an amount of power input into the mixer motor at the first viscosity and at the second viscosity.

13. The method of claim 1, wherein the beverage machine comprises multiple chambers adapted to be cooled with the compressor with each chamber being cooled in a cooling cycle, and further comprising temporarily changing the cooling cycle of a first chamber to coincide with a cooling cycle of at least one other of the chambers to allow the compressor to cool the first chamber and the at least one other chamber concurrently.

14. The method of claim 13, further comprising deactivating the compressor when a predefined product viscosity occurs to end the cooling cycle of one or more chambers.

15. The method of claim 13, further comprising deactivating the compressor when a predefined product temperature occurs to end the cooling cycle of one or more chambers.

16. A system for reducing energy input into a beverage machine, comprising:
at least one product chamber adapted to contain a product;
a compressor motor with a compressor adapted to cool the product;
a mixer motor with a mixer adapted to mix the product in the product chamber;
a controller coupled to the compressor motor and mixer motor and adapted to:
activate the compressor motor to cool the product so that the product reaches a predefined first product condition;
activate the mixer motor with the mixer to mix the product in the product chamber;
deactivate the compressor motor;
deactivate the mixer motor to stop the mixer from mixing based on an occurrence of a predefined first condition while the product is in the chamber and the compressor motor is deactivated;
reactivate the mixer motor to mix the product in the product chamber based on an occurrence of a predefined second condition different from the first condition while the product is in the chamber and the compressor motor is deactivated; and
reactivate the compressor motor when the product reaches a predefined second product condition.

17. The system of claim 16, wherein an activation time for the mixer motor compared to a sum of the activation time and a deactivation time for the mixer motor while the compressor motor is deactivated is expressed as an mixer activation percentage, and the activation percentage is 10% to 90%.

18. The system of claim 17, wherein the activation percentage is 25% to 75%.

19. The system of claim 17, wherein the activation percentage is 33% to 50%.

20. The system of claim 16, wherein the predefined first condition comprises a first time.

21. The system of claim 20, wherein the predefined second condition comprises a second time.

22. The system of claim 16, wherein the predefined first product condition comprises a first product temperature of the product.

23. The system of claim 22, wherein the predetermined second product condition comprises a second product temperature of the product different from the first product temperature.

24. The system of claim 16, wherein the predefined first product condition comprises a first viscosity of the product in the chamber.

25. The system of claim 24, wherein the predefined second product condition comprises a second viscosity of the product in the chamber different from the first viscosity.

26. The system of claim 25, wherein a difference between the first viscosity and the second viscosity is based on a difference in an amount of power input into the mixer motor at the first viscosity and at the second viscosity.

27. The system of claim 2, wherein the beverage machine comprises multiple chambers adapted to be cooled with the compressor with each chamber being cooled in a cooling cycle, and further comprising the controller being adapted to temporarily change the cooling cycle of a first chamber to coincide with a cooling cycle of at least one other of the chambers to allow the compressor to cool the first chamber and the at least one other chamber concurrently.

28. The system of claim 27, further comprising the controller being adapted to deactivate the compressor when a predefined product viscosity occurs to end the cooling cycle of one or more chambers.

29. The system of claim 27, further comprising the controller being adapted to deactivate the compressor when a predefined product temperature occurs to end the cooling cycle of one or more chambers.
